(19) United States
(12) Patent Application Publication
(10) Pub. No.: US 2013/0068381 A1
(43) Pub. Date: Mar. 21, 2013

(54) SLEEVE MANUFACTURE

(71) Applicant: Steven TCHIRA, N. Miami Beach, FL (US)

(72) Inventor: Steven TCHIRA, N. Miami Beach, FL (US)

(21) Appl. No.: 13/236,801

(22) Filed: Sep. 20, 2011

(51) Int. Cl. B32B 38/10; B32B 37/12

(52) U.S. Cl. 156/250

(57) ABSTRACT

A sleeve is formed by applying a pattern of adhesive on one or more elongate sheets of material, combining the elongate sheets using the applied adhesive, and cutting the elongate sheets using cutting guides conforming to the pattern of adhesive, thereby forming separate sleeves bound by peripheral seams containing adhesive. Movement of the combined sheets into the cutter, and movement of the cutter, are combined by mechanical actuators and or processors to facilitate automated production of the sleeves.

### FIELD OF THE INVENTION

The invention relates to a system and method for manufacturing paper sleeves from sheet stock, and in particular, forming conical sleeves for bundling flowers.

### BACKGROUND OF THE INVENTION

Sleeves are used for protecting and presenting products in commerce, for example flowers or plants. Sleeves may be formed by wrapping a single sheet of material about a bundle of plants, or may be pre-formed by rolling single sheets, or by combining multiple sheets, for example by melting seams containing polymeric material.

### SUMMARY OF THE INVENTION

In an embodiment of the disclosure, a sleeve is formed by applying a first predetermined pattern of adhesive onto a first elongate sheet using a application roller having an embossed resilient pattern corresponding to the first predetermined pattern, the embossed resilient pattern operative to transfer adhesive from an adhesive supply to the first elongate sheet as the application roller is rotated in spaced conformity relative to the first elongate sheet; adhering, using the predetermined pattern of adhesive, a second elongate sheet to the first elongate sheet, thereby forming a web including the predetermined pattern of adhesive disposed between the first sheet and the second sheet; and passing the web through a cutter operative to separate sections of the web comprising adhered first and second sheet sections bounded together along opposing peripheral edges by the adhesive.

In alternative embodiments, the predetermined pattern of adhesive is applied to the second elongate sheet; the predetermined pattern of adhesive forms at least one line extending at an angle transversely across the first elongate sheet relative to a longitudinal axis of the first elongate sheet; the predetermined pattern of adhesive forms two non-parallel lines extending at an angle transversely across the first elongate sheet relative to a longitudinal axis of the first elongate sheet; each of the two lines forms the same angle relative to a side edge of the first elongate sheet; the first elongate sheet comprises paper; the first and second elongate sheet comprise Kraft paper; the first and second elongate sheet comprise paper of between 10 and 100 gsm; the first and second elongate sheets comprise paper.

In other embodiments, the sleeve is entirely formed of materials which readily degrade in a natural environment; the sleeve is sized and dimensioned to contain cut plants having stems, the stems extendable through an open end of the sleeve; the adhesive is water-based or solvent free, and rapidly degrades in a natural environment; and adhesive is applied by being first transferred from a supply tray to an intermediate roller, and from the intermediate roller to the application roller, thereby applying a layer of adhesive having a predetermined thickness onto the embossed resilient pattern; the intermediate roller and or the application roller are heated to maintain the adhesive in a liquid state.

In yet other embodiments, forming a sleeve further comprises cutting the adhered first and second elongate sheets using one or more cutting blades moveable from a position above the adhered sheets to a position below the adhered sheets, thereby separating individual sleeves along the predetermined pattern of adhesive; the first and second adhered sheets are supported by a surface, the surface being provided with grooves into which the cutting blades may move after cutting the adhered sheets; the cutting blades may be moved manually or by a mechanical actuator; cutting is performed using a laser; and the cutting blades may be moved by a first mechanical actuator, and wherein the adhered sheets are positioned under the cutting blades by a second mechanical actuator, the first mechanical and second mechanical actuators coordinated in their respective moving and positioning.

In another embodiment of the disclosure, a sleeve is formed by applying a first predetermined pattern of adhesive onto a first elongate sheet using a rotating cylinder having an embossed resilient pattern corresponding to the first predetermined pattern, the embossed resilient pattern operative to transfer adhesive from an adhesive supply to the first elongate sheet as the rotating cylinder is rotated in spaced conformity relative to the first elongate sheet; adhering, using the predetermined pattern of adhesive, a second elongate sheet to the first elongate sheet, thereby forming a web including the predetermined pattern of adhesive disposed between the first sheet and the second sheet; and passing the web through a cutter operative to separate sections of the web comprising adhered first and second sheet sections bounded together along opposing peripheral edges by the adhesive, the cutter including one or more cutting blades moveable from a position above the web to a position below the web, thereby separating individual sleeves from the web.

In a further embodiment, a sleeve is formed by applying a first predetermined pattern of adhesive onto a first elongate sheet using a rotating cylinder having an embossed resilient pattern corresponding to the first predetermined pattern, the embossed resilient pattern operative to transfer adhesive from an adhesive supply to the first elongate sheet as the rotating cylinder is rotated in spaced conformity relative to the first elongate sheet; adhering, using the predetermined pattern of adhesive, a second elongate sheet to the first elongate sheet, thereby forming a web including the predetermined pattern of adhesive disposed between the first sheet and the second sheet; forming the web into a roll; and passing the web from the roll through a cutter using a first mechanical actuator, the cutter operative to separate sections of the web comprising adhered first and second sheet sections bounded together along opposing peripheral edges by the adhesive, the cutter including one or more cutting blades moveable from a position above the web to a position below the web, thereby separating individual sleeves from the web, the passing of the first mechanical actuator coordinated with the moving of the second mechanical actuator.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts a sleeve of the disclosure;

FIG. 2 depicts a breakaway view of the sleeve of FIG. 1, illustrating a joined seam in accordance with the disclosure;

FIG. 3 illustrates an exemplary device for applying adhesive in a predetermined geometric pattern in accordance with the disclosure;

FIG. 4 illustrates an exemplary device for binding sheets formed using the device of FIG. 3, to form a web in accordance with the disclosure;

FIG. 5 illustrates an exemplary device for cutting the web of FIG. 4, to form individual sleeves;

FIG. 6 illustrates a cutting device of the disclosure, that may be used with the device of FIG. 5 to cut sleeves from a web of the disclosure;

FIG. 7 depicts a geometric pattern of the disclosure for applying adhesive in order to form a web defining sleeves having alternating shapes; and

FIG. 8 depicts an alternative geometric pattern of the disclosure for applying adhesive in order to form a web defining sleeves of alternating width.

### DETAILED DESCRIPTION OF THE INVENTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

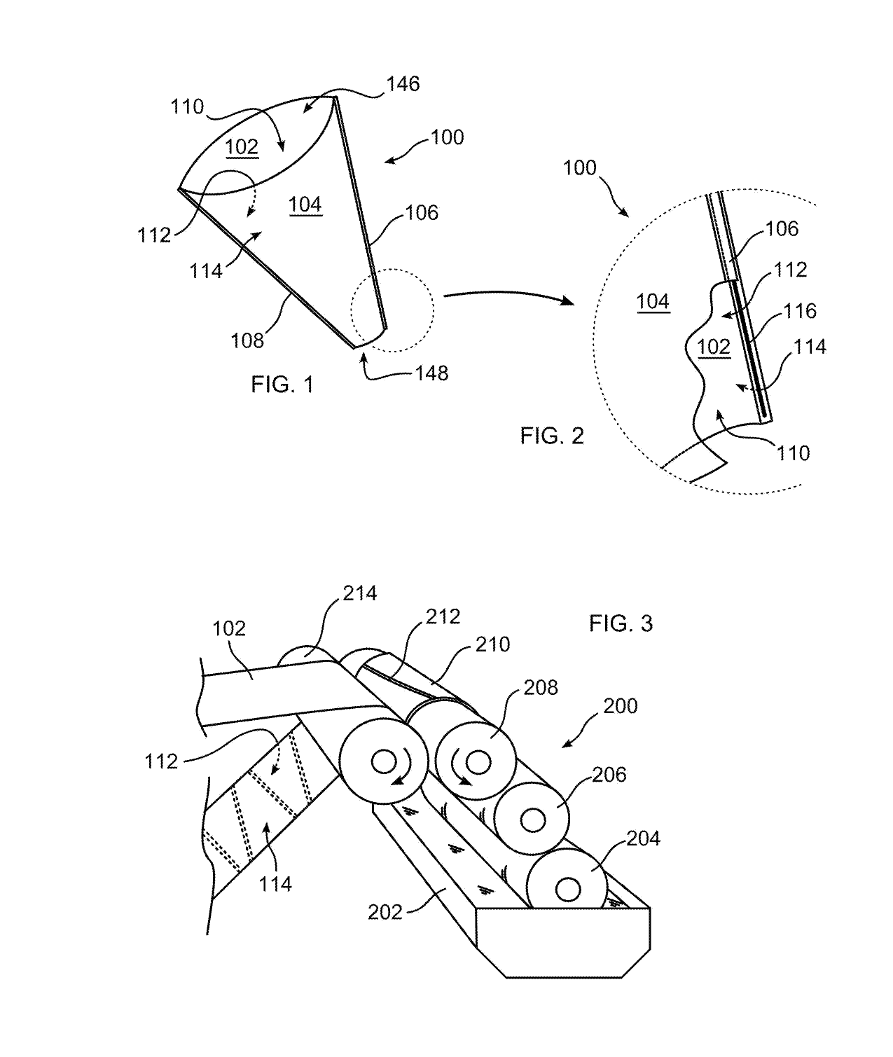

With reference to FIGS. 1-2, a sleeve 100 is formed of two or more elongate sheets 102, 104 of planar material, mutually bound along seams 106, 108. Sleeve 100 may be folded to be flat or substantially flat, and expanded by forming a space between a portion of sheets 102, 104, thereby creating an inner containment area 110, and an open top end 146 and bottom end 148.

Seams 106, 108 are formed by adhering mutually facing edge portions of sheets 102, 104. A width of seams 106, 108 is determined by a strength of an adhesive securing sheets 102, 104 together along a seam 106, 108, whereby a smaller or narrower seam 106, 108 may be formed as an adhesive strength of the bond between sheets 102, 104 becomes stronger.

Sheets 102, 104 may be formed of any material which may be mutually adhered, and is selected with consideration given to the material to be contained, the conditions of the containment, and the cost of the material. For containing living plants, for example flowers, it is advantageous if sheets 102, 104 are resistant to degradation due to moisture, and have sufficient strength to offer protection to delicate living structures. Sheets 102, 104 may be formed of opaque or transparent material, and may be decorated by printing, embossing, reliefs, or perforations, on one or both sides of a sheet. Example materials include polymeric materials, including but not limited to polypropylene, BOPP (Biaxially Oriented Polypropylene), polystyrene, nylon, mylar, tyvek, cellophane, fabric, woven material, fibrous material, webbed material, paper, cardboard, metalized material, foil, metallic foil, foam, open cell foam, closed cell foam, and multilayer materials comprising any combination of materials. One or both of sheets 102, 104 may be formed of a biodegradable material, for example a polylactide (PLA) material. Sheets 102, 104 may be printed with an arbitrary, repeating, or representational predetermined pattern, or any image or indicia.

Either or both of sheets 102, 104 may be composed of multiple layers of differing or like materials. Sheets 102, 104 define an inner surface 112 facing inner containment area 110, and an outer surface 114 facing away from inner containment area 110. Inner surface 112, for example, may be polymeric, or otherwise resistant to moisture and or tearing. Outer surface 114 may be, for example, cellulosic, selected to be comfortable to grasp or grip by a human hand. Outer surface 114 may further have greater or lesser moisture resistance, strength, elasticity, texture, or other properties than inner surface 112. Sheets 102, 104 may be shaped differently than each other. Sheets 102, 104 may advantageously be formed of a material that readily passes humidity from inner containment area 110 to an exterior of sleeve 100, particularly for living plants.

The disclosure is particularly advantageous for forming sleeves including paper material, which is positively adhered by adhesive, and cannot be joined by melting. Sheets 102, 104 are advantageously formed with a material which eliminates or reduces humidity to which plant, and particularly floral contents, may be exposed during packing, storage, transport, and distribution, and or enables dissipation of humidity that may be formed within sleeve 100, which has been introduced by the contained material, and particularly introduced by living material such as plants. Paper of between 30 and 60 gsm have been found advantageous in these regards, however thinner or thicker material, for example between 10 and 100 gsm, and other forms of paper, may advantageously be used, depending on the rigors of the application. More particularly, Kraft paper has been found advantageous, due to its physical properties, including breathability, strength, and reduced cost relative to other materials which may be available, including polymeric material. Materials for forming sheets 102, 104 are advantageously provided in rolls having a maximum weight of 100 kg each, so that they may be handled expeditiously within the production facility; however, much lighter or heavier rolls may be used, as is understood within the art.

Sheets 102, 104 may be composed of different materials, or materials having a different appearance. This may be advantageous, for example, where one sheet 102, 104 faces a potential consumer and the other sheet 102, 104 faces away from a potential consumer, for example in a retail display. One sheet 102, 104 may have a greater resistance to sunlight, chemicals, or moisture, for example, than the other sheet 102, 104, and sleeve 100 is so arranged when stored, transported, or displayed, to take advantage of the relative difference in properties of sheets 102, 104.

FIG. 2 illustrates the portion of FIG. 1 indicated within the dashed circle, with a portion of sleeve 104 broken away, and further showing a length of adhesive 116 applied to sheet 102 along seam 106, in accordance with a predetermined geometric configuration. It should be understood that adhesive 116 may be applied to sheet 102, 104, or both, and that a different adhesive may be applied to each of sheet 102, 104. Alternatively, one or both of sheet 102, 104 may be treated to enhance bonding, for example by being provided with a roughened or textured surface. Adhesive 116 may be used to bond sheets 102, 104 while adhesive 116 is at room temperature, or at a reduce or elevated temperature, as determined by the most effective temperature range for operation and strength of adhesive 116. Adhesive 116 may be applied to one or both of sheet 102, 104 at a first temperature, and may be heated or cooled to a second temperature at a later point in time, for example when sheets 102, 104 are positioned in mutual engagement. Adhesive 116 may be responsive to pressure, for example adhesive may be forced into interstices of one or both of sheet 102, 104 by pressure applied to an opposing side of sheet 102, 104, for example by a nip roller. Alternatively or additionally, adhesive 116 may be disposed in microcapsules which burst upon the application of pressure, releasing a contained adhesive 116. Various adhesives or glues which may be used include drying adhesives, including for example solvent based adhesives such as white glue, contact adhesives, and rubber cements; polymer dispersion adhesives such as polyvinyl acetate; pressure sensitive adhesives which may or may not be removable; contact adhesives, including for example natural rubber and polychloroprene; hot adhesives or thermoplastic adhesives, including for example ethylene-vinyl acetate; photosensitive adhesives; heat curing adhesives, for example epoxies, urethanes, and polyimides; moisture curing adhesives, including for example cyanoacrylates and urethanes; natural adhesives including, for example starches and caseins; synthetic adhesives including elastomers, thermoplastics, emulsions, and thermosets. In consideration of environmental concerns, water-based or solvent free adhesives are advantageously used, in order to produce an end product sleeve 100 which may degrade rapidly in nature or an environment exposed to nature, for example in a landfill, without leaving harmful residues.

Referring now to FIG. 3, applicator 200 may be used to apply adhesive 116 to sheet 102 and or 104 in accordance with a predetermined pattern. A trough or supply tray 202 releasably contains a supply of adhesive 116 in liquid form. Tray 202 may be heated, or may include a heater or heating coil, not shown, operative to render or maintain adhesive 116 in liquid form. An adhesive pickup roller 204 is rotated within liquid adhesive 116 to become coated with a liquid film of adhesive 116. Pickup roller 204 rotates in spaced conformity to transfer roller 206, whereby a film of uniform thickness is developed upon a surface of transfer roller 206. A printing or application roller 208 is provided with a printing or application pad 210 surrounding application roller 208 and extending along a length thereof. Printing pad 210 has a raised or embossed edge surface 212 forming a mirror image of the pattern of adhesive 116 to be printed upon sheet 102 or 104. Edge surface 212 is positioned in spaced conformity to transfer roller 206, whereby a desired quantity of adhesive 116, in a layer of predetermined thickness, is advantageously transferred from transfer roller 206 to raised edge surface 212, as transfer roller 206 and application roller 208 rotate relative to each other. Sheet support roller 214 movably passes sheet 102 or 104 in spaced conformity to printing pad 210, whereby raised edge surface 212 may press upon sheet 102 or 104, thereby transferring a desired quantity of adhesive 116 to sheet 102 or 104, in the desired pattern. Edge surface 212 and or printing pad 210 are advantageously resilient, so that a desired pressure may be generated between edge surface 212 and sheet 102 or 104, in order to effectively transfer a desired quantity of adhesive to sheet 102 or 104. Rollers 204, 206, 208, 210 and or 214 may be driven by a motor or other mechanical actuator, not shown, and may be controlled by a processor, additionally not shown.

Any of rollers 204, 206, 208, or 214 may be temperature controlled, including being heated or cooled, to maintain a desired temperature of adhesive 116 and or sheet 102, 104. Sheet 102 or 104, after being printed with adhesive 116, may be cooled prior to rolling for storage, by passing sheet 102 or 104 over a cold plate, or passed in the path of forced air, or by using other known means. In an embodiment, a rolled sheet 102 or 104, having been printed with adhesive 116, is not used for a period of time, for example one to ten hours, and advantageously for a period of five hours, before being adhered to form a precursor to sleeve 100. A lining sheet or release layer, not shown, may be rolled together with sheet 102, 104, to prevent adhesive 116 from adhering to an adjacent rolled layer of sheet 102, 104. Rollers 204, 206, 208, or 214 may be made from any suitable material, including metal, natural material, polymeric material, or resilient material.

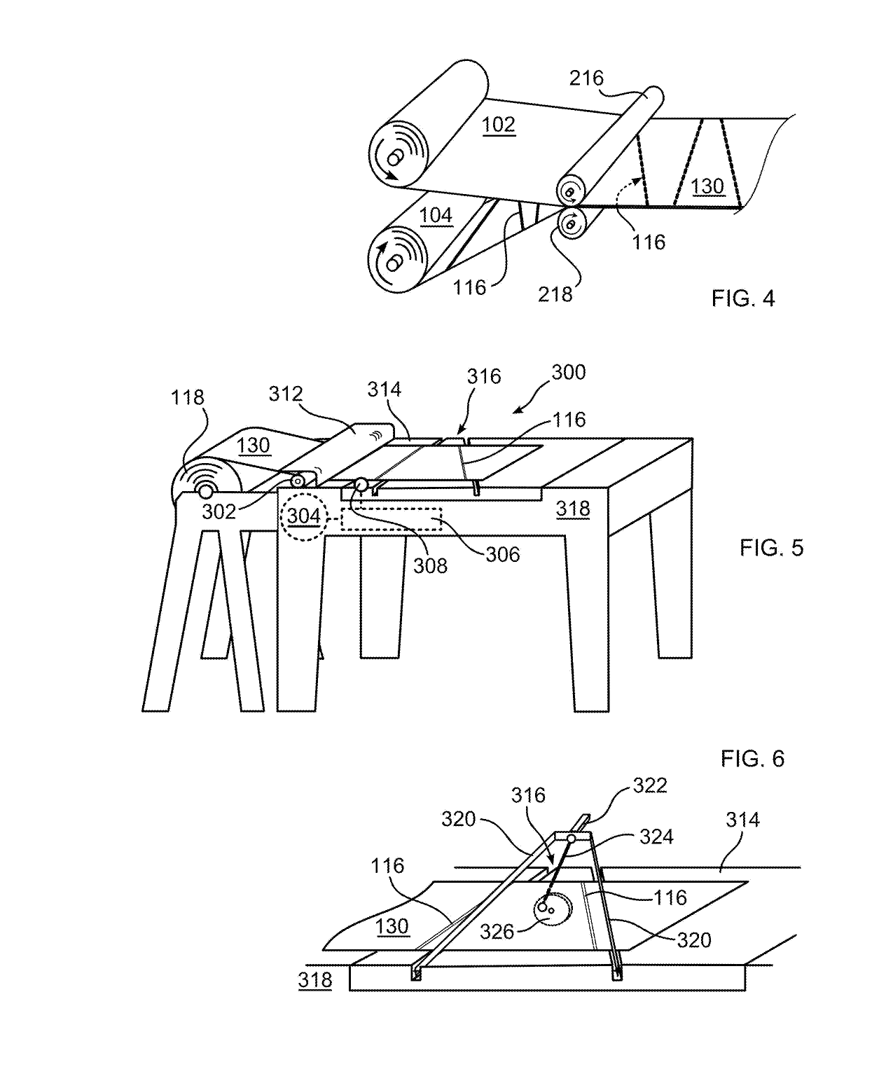

Referring now to FIG. 4, sheet 102 and 104 are combined to form sleeve 100. In this embodiment, nip rollers 216, 218 press sheets 102, 104 together, with printed length of adhesive 116 therebetween, disposed upon sheet 102 and or 104. Nip rollers 216, 218 may be biased along a longitudinal axis, relative to each other, in order to apply a more uniform pressure along sheets 102, 104, as is known in the art, and may further be heated and or cooled in order to foster a desired temperature of sheets 102, 104 and adhesive 116. Combined sheets 102, 104, hereinafter web 130, after being mutually assembled and adhered together, may be cooled prior to rolling for storage, by passing web 130 over a cold plate, or passed in the path of forced air, or by using other known means. In an embodiment, rolled web 130 is not used for a period of time, for example one to ten hours, and advantageously for a period of five hours, before being cut to form sleeve 100.

In FIG. 5, a supply roll 118 containing combined web 130 is cut to form sleeves 100 in cutting device 300. Supply roll 118 rotatably dispenses web 130 to a feed roller 302. Rotation of roll 118 and or feed roller 302 may be controlled by a motor 304 or other mechanical actuator cooperative with a processor or computer 306, and one or more sensors 308 operative to communicate a position of a pattern of adhesive 116 relative to a cutting location 310. In an embodiment, a feed guide 312 controls movement of combined sheets 102, 104 through cutter 300. In one embodiment, feed guide 312 smooths web 130, and arrests movement of web 130 during cutting and separation of individual sleeves. In another embodiment, feed guide 312 grips and advances web 130, in cooperation with a supporting surface 314, a predetermined amount, for example as determined using sensor 126, or advanced a fixed distance, so that successive lengths of adhesive 116 are positioned to be cut. Feed guide 312 may be positioned and moved using any known means, including one or more motors, servo controls, or other mechanical, electrical, or electronic means, for example stepper or servo controlled motors or actuators, not shown. For example, in addition or as an alternative to one or more electric motors, pneumatic or hydraulic actuators (not shown) may be used for controlling feed roller 302, feed guide 312, cutting blades 320 (described below), or any other mechanical component of the disclosure.

Cutting grooves 316 are advantageously provided within surface 314, to preserve and guide a cutting implement. Grooves 316 are oriented to have a matching configuration with respect to lengths of adhesive 116 within web 130. Accordingly, once web 130 and adhesive 116 is aligned over grooves 316, a cutting implement may be drawn through web 130 to separate individually adhered sleeves, as shown in FIGS. 1-2.

More particularly, sleeves 100 comprise successive sections of sheets 102, 104 bound along opposing peripheral side edges with a seam 106, 108 joined by adhesive 116. In one embodiment, sleeve 102, 104 edges perpendicular to the opposed peripheral side edges, forming top end 146 and bottom end 148 of sleeve 100, are not adhered, and may therefore be moved apart, expanding adhered sheet 102, 104 sections to form openings in top end 146 and bottom end 148, into inner containment area 110. For containing plants or flowers, one or more stems are inserted into sleeve 100 so that the stems may project through the open bottom end 148, and the flowering or enlarged end of the plant may reside within, and or project from open top end 146. In this manner, the plants may be assembled and maintained in a mutually conforming configuration, or bunched, and are thereby protected from environmental conditions and or mutual abrasion due to vibration.

In another embodiment, top end 146 or bottom end 148 may be provided with length of adhesive, wherein either top ends 146 or bottom ends 148 of sheets 102, 104 are adhered using the apparatus and methods described herein. As such, a fillable cone is formed. In yet another embodiment, top and bottom ends 146, 148 of sheets 102, 104 are adhered as described herein, however material to be contained is placed between sheets 102, 104, advantageously before sheets 102, 104 are adhered along all sides. Alternatively, material to be contained may be placed within a sealed sleeve 100 by leaving a gap or forming an opening in one or both of sheets 102, 104, for example by injection, and later optionally sealing the opening.

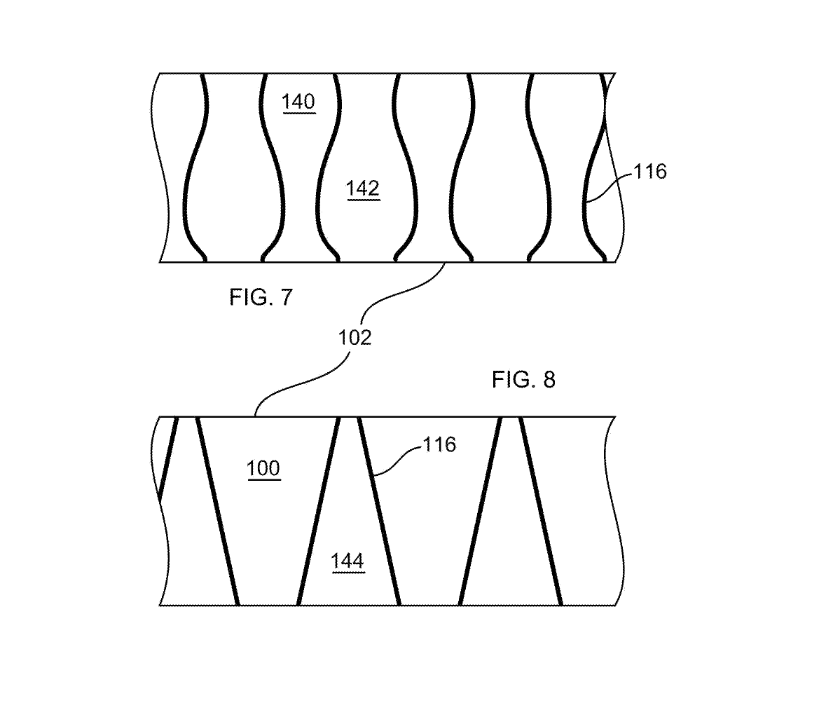

In one embodiment, shown in FIG. 6, cutting blades 320 are arranged above web 130, pivotally connected to surface 314, for example near an end of grooves 316, so that a portion of a length of cutting blades 320 may rise above surface 314 admitting passage of web 130, and thereafter fall below surface 314 into grooves 316, cutting web 130 therebetween. Cutting blades 320 are arranged to correspond to lengths of adhesive 160, and are of sufficient strength, sharpness, and dimension to separate sheets 102, 104 and adhesive 116, whereby a portion of adhesive 116 remains along each side of the cut portion of web 130, and wherein each sleeve 100 is adhered along seams 106, 108, as shown in FIGS. 1-2. In one embodiment cutting blades 320 are serrated, and form perforations, whereby sections defining sleeves 100 may be fanfolded, rolled, or otherwise packaged, whereby individual sleeves 100 may be torn along the cut perforation to separate a sleeve from remaining sleeves as needed.

Cutting blades 320 may be formed with any suitable material of sufficient strength and durability, for example, a metal, ceramic, or plastic material, including as examples stainless steel, carbon steel, laminate, and titanium. It should be understood that although two cutting blades 320 are shown in FIG. 6, one or more than two blades may be used, including multiple cutting stations.

Cutting blades 320 may be manually raised and lowered, for example through use of handle 322. In the embodiment shown in FIG. 6, a connector 324 is pivotally connected to blades 320 and a cam 326, whereby movement of blades 320 may be automated. Cam 326 may be connected to a motor, for example motor 304, and synchronized with the movement of web 130, whereby web 130 is properly aligned for cutting, and blades 320 then move to web 130, without assistance by manual operation. Computer 306 may be used, with or without sensor 308, to control a timed operation of blades 320 and advancement of web 130.

It should be understood that other methods of cutting individual sleeves from web 130 may be used, including reciprocating blades, rotary blades, cutting drums, and other methods known in the art, or hereinafter developed.

Cutting device 300 may advantageously be provided on or incorporated within a supporting cart or table 318. Apparatus (not shown) operative to collate cut sleeves, as well as to bale or package cut sleeves, for example within corrugated cardboard boxes, may be provided at a location downstream from cutting grooves 316. Alternatively, cut sleeves may be collected and or packaged manually.

FIGS. 1-6 illustrate a predetermined pattern of two non-parallel adhesive 116 lines extending transversely across sheets 102 and or 104 relative to a longitudinal axis of sheet 102 or 104, thereby defining two, similar trapezoidal shapes. In other embodiments, other shapes may alternatively be defined, as illustrated for example in FIGS. 7 and 8. More particularly, FIG. 7 illustrates two sleeves 140, 142 defined by lengths of adhesive 116 on sheet 102 or 104, each having curved side surfaces, and each having different shapes. Cutting blades 320 may be formed to have a corresponding shape. In FIG. 8, lengths of adhesive 116 are linear, however two different shapes are defined, including a sleeve 100 and a relatively more narrow sleeve 144. Accordingly lines may form like or dissimilar angles relative to each other. In accordance with the disclosure, tubes or tubular sleeves may be formed by arranging lengths of adhesive 116 which are parallel, or form like angles relative to each other. Other shapes and sizes are additionally possible, as would be understood by one skilled in the art.

In an alternative embodiment of the disclosure, cutting device 300 may use laser light to cut web 130, the laser light substituting for blades 320. A digital cutting machine incorporating laser light cutting may advantageously be combined with other aspects of the disclosure, including for example roll feed from supply roll 118, advantageously coordinating laser cutting with any or all of motor 304, feed roller 302, computer 306, sensor 308, and feed guide 312.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

All references cited herein are expressly incorporated by reference in their entirety. In addition, unless mention was made above to the contrary, it should be noted that all of the accompanying drawings are not to scale. There are many different features to the present invention and it is contemplated that these features may be used together or separately. Thus, the invention should not be limited to any particular combination of features or to a particular application of the invention. Further, it should be understood that variations and modifications within the spirit and scope of the invention might occur to those skilled in the art to which the invention pertains. Accordingly, all expedient modifications readily attainable by one versed in the art from the disclosure set forth herein that are within the scope and spirit of the present invention are to be included as further embodiments of the present invention.

What is claimed is:

1. A method of forming a sleeve, comprising:
applying a first predetermined pattern of adhesive onto a first elongate sheet using a application roller having an embossed resilient pattern corresponding to the first predetermined pattern, the embossed resilient pattern operative to transfer adhesive from an adhesive supply to the first elongate sheet as the application roller is rotated in spaced conformity relative to the first elongate sheet;
adhering, using the predetermined pattern of adhesive, a second elongate sheet to the first elongate sheet, thereby forming a web including the predetermined pattern of adhesive disposed between the first sheet and the second sheet; and
passing the web through a cutter operative to separate sections of the web comprising adhered first and second sheet sections bounded together along opposing peripheral edges by the adhesive.

2. The method of claim 1, wherein the predetermined pattern of adhesive is applied to the second elongate sheet.

3. The method of claim 1, wherein the predetermined pattern of adhesive forms at least one line extending at an angle transversely across the first elongate sheet relative to a longitudinal axis of the first elongate sheet.

4. The method of claim 1, wherein the predetermined pattern of adhesive forms two non-parallel lines extending at an angle transversely across the first elongate sheet relative to a longitudinal axis of the first elongate sheet.

5. The method of claim 4, wherein each of the two lines forms the same angle relative to a side edge of the first elongate sheet.

6. The method of claim 1, wherein the first elongate sheet comprises paper.

7. The method of claim 1, wherein the first and second elongate sheet comprise Kraft paper.

8. The method of claim 1, wherein the first and second elongate sheet comprise paper of between 10 and 100 gsm.

9. The method of claim 1, wherein the first and second elongate sheets comprise paper.

10. The method of claim 1, wherein the sleeve is entirely formed of materials which readily degrade in a natural environment.

11. The method of claim 1, wherein the sleeve is sized and dimensioned to contain cut plants having stems, the stems extendable through an open end of the sleeve.

12. The method of claim 1, wherein the adhesive is water-based or solvent free, and rapidly degrades in a natural environment.

13. The method of claim 1, wherein adhesive is applied by being first transferred from a supply tray to an intermediate roller, and from the intermediate roller to the application roller, thereby applying a layer of adhesive having a predetermined thickness onto the embossed resilient pattern.

14. The method of claim 13, wherein the intermediate roller and or the application roller are heated to maintain the adhesive in a liquid state.

15. The method of claim 1, further comprising cutting the adhered first and second elongate sheets using one or more cutting blades moveable from a position above the adhered sheets to a position below the adhered sheets, thereby separating individual sleeves along the predetermined pattern of adhesive.

16. The method of claim 15, wherein the first and second adhered sheets are supported by a surface, the surface being provided with grooves into which the cutting blades may move after cutting the adhered sheets.

17. The method of claim 15, wherein the cutting blades may be moved manually or by a mechanical actuator.

18. The method of claim 15, wherein the cutting blades may be moved by a first mechanical actuator, and wherein the adhered sheets are positioned under the cutting blades by a second mechanical actuator, the first mechanical and second mechanical actuators coordinated in their respective moving and positioning.

19. A method of forming a sleeve, comprising:
applying a first predetermined pattern of adhesive onto a first elongate sheet using a rotating cylinder having an embossed resilient pattern corresponding to the first predetermined pattern, the embossed resilient pattern operative to transfer adhesive from an adhesive supply to the first elongate sheet as the rotating cylinder is rotated in spaced conformity relative to the first elongate sheet;
adhering, using the predetermined pattern of adhesive, a second elongate sheet to the first elongate sheet, thereby forming a web including the predetermined pattern of adhesive disposed between the first sheet and the second sheet; and
passing the web through a cutter operative to separate sections of the web comprising adhered first and second sheet sections bounded together along opposing peripheral edges by the adhesive, the cutter including one or more cutting blades moveable from a position above the web to a position below the web, thereby separating individual sleeves from the web.

20. A method of forming a sleeve, comprising:
applying a first predetermined pattern of adhesive onto a first elongate sheet using a rotating cylinder having an embossed resilient pattern corresponding to the first predetermined pattern, the embossed resilient pattern operative to transfer adhesive from an adhesive supply to the first elongate sheet as the rotating cylinder is rotated in spaced conformity relative to the first elongate sheet;
adhering, using the predetermined pattern of adhesive, a second elongate sheet to the first elongate sheet, thereby forming a web including the predetermined pattern of adhesive disposed between the first sheet and the second sheet;
forming the web into a roll; and
passing the web from the roll through a cutter using a first mechanical actuator, the cutter operative to separate sections of the web comprising adhered first and second sheet sections bounded together along opposing peripheral edges by the adhesive, the cutter including one or more cutting blades moveable from a position above the web to a position below the web, thereby separating individual sleeves from the web, the passing of the first mechanical actuator coordinated with the moving of the second mechanical actuator.
